(19) United States
(12) Patent Application Publication
(10) Pub. No.: US 2026/0119291 A1
(43) Pub. Date: Apr. 30, 2026

(54) METHOD AND SYSTEM FOR A UNIFIED LOAD CONTROLLER IN PROCESSING AND MANAGING BULK DATA

(71) Applicant: JPMorgan Chase Bank, N.A., New York, NY (US)

(72) Inventors: Varun MONGA, Bengaluru (IN); Lakshmaiah EDARA, Middletown, DE (US); Ashish LAMICHHANE, Glen Mills, PA (US); Kiran SEKHARAMAHANTHI, Newark, DE (US)

(73) Assignee: JPMorgan Chase Bank, N.A., New York, NY (US)

(21) Appl. No.: 18/978,808

(22) Filed: Dec. 12, 2024

(30) Foreign Application Priority Data
Oct. 29, 2024 (IN) 202411082649

(51) Int. Cl. G06F 9/54; G06F 9/455; G06Q 20/38

(52) U.S. Cl. CPC G06F 9/547; G06F 9/45558; G06Q 20/38; G06F 2009/45562

(57) ABSTRACT

A method and system for bulk data processing and management. The method includes receiving a query with a transaction request and a bulk data request; generating a bulk application program interface (API) with a remote application framework integrated with a flux application; constructing a first continuous stream of digital data from a distributed database management system via the flux application for transmission to the bulk API; and constructing a second continuous stream of the digital data from the bulk API for transmission to a client interface via the remote application framework. The second continuous stream of the digital data being based on the first continuous stream. The method also includes deriving resulting information regarding the transaction request from parsing the second continuous stream of the digital data; and processing the resulting information for storage in a cache for access and management and display to the client.

### CROSS-REFERENCE TO RELATED APPLICATIONS

This application claims priority benefit from Indian Application No. 202411082649, filed October 29, 2024 in the India Patent Office, which is hereby incorporated by reference in its entirety.

### FIELD OF DISCLOSURE

This technology generally relates to methods and systems for a unified load controller in processing and managing bulk data.

### BACKGROUND

In transaction utilities, thousands up to millions of transactions are frequently being handled and stored across a variety of different systems and operating environments. These transactional data (e.g., financial transaction data) may be provided via performant and resilient application program interfaces (APIs) to different channels, such as the financial institution’s webpage. For instance, if a user has a financial account (e.g., bank account) and the user logs in online to view the recent financial transactions information, this experience is powered by the financial institution’s utility APIs.

However, these APIs are presently ill-equipped to handle user queries wherein a single query may have a transaction request involving high-volume/bulk data transaction. For instance, a single query by a user may involve handling thousands to millions of transaction data in order to process and generate a response to that query. The present techniques in the status quo are unable to process such a query efficiently and timely to generate a near instantaneous response to the user in a manner that minimizes network congestion and burden on computing resources.

Accordingly, there is a need for techniques for an improved load controller capable of handling high-volume processing and managing of bulk data.

### SUMMARY

The present disclosure, through one or more of its various aspects, embodiments, and/or specific features or sub-components, provides, inter alia, various systems, servers, devices, methods, media, programs, and platforms for bulk data processing and management.

According to an aspect of the present disclosure, a method for bulk data processing and management may be provided. The method for bulk data processing and management may be implemented by at least one processor. The method may include receiving a query with a transaction request that may include a bulk data request via a transmission from a client interface; and generating a bulk application program interface (API) comprising a remote application framework integrated with a flux application. The method may further include constructing a first continuous stream of digital data from a distributed database management system via the flux application for transmission to the bulk API; and constructing a second continuous stream of the digital data from the bulk API for transmission to the client interface via the remote application framework, wherein the second continuous stream of the digital data is based on the first continuous stream of the digital data. The method may further include deriving resulting information regarding the transaction request from parsing the second continuous stream of the digital data by the client interface in correlation with the bulk API; and processing the resulting information for storage in a cache for access and management and display to the client via the client interface.

Each of the constructing the first continuous stream of the digital data and the constructing the second continuous stream of the digital data further may include setting a predetermined fix number of transactions per batch of the digital data.

The method may further include: generating a customized aggregate data model that manages transaction counts based on the first and the second continuous streams of the digital data; managing and storing the transaction counts via the customized aggregate data model; and integrating the bulk API with the customized aggregate data model.

The bulk API may act as a unified load controller; and the remote application framework may include a cross-platform remote procedure call framework enabling service operations to a remote server application across different operating platforms.

The constructing the first continuous stream of the digital data may include performing a backend call from the flux application to the distributed database management system for the digital data.

The method may further include: constructing at least one virtual machine instance, based on the query, that interacts with the client interface and the bulk API; and constructing at least one granular data partition level in the distributed database management system that stores the digital data based on the query, wherein the at least one granular data partition level interacts with the at least one virtual machine.

The method may further include performing an automatic scaling of the least one virtual machine instances correlating with a quantity of the query received.

According to yet another embodiment, a computing apparatus for bulk data processing and management may be provided. The computing apparatus may include: a processor; a memory; a display; and a communication interface coupled to each of the processor, the memory, and the display.

The processor may be configured to: receive a query with a transaction request comprising a bulk data request via a transmission from a client interface; and generate a bulk application program interface (API) comprising a remote application framework integrated with a flux application. The processor may be further configured to: construct a first continuous stream of digital data from a distributed database management system via the flux application for transmission to the bulk API; and construct a second continuous stream of the digital data from the bulk API for transmission to the client interface via the remote application framework, wherein the second continuous stream of the digital data is based on the first continuous stream of the digital data. The processor may be further configured to: derive resulting information regarding the transaction request from parsing the second continuous stream of the digital data by the client interface in correlation with the bulk API; and process the resulting information for storage in a cache for access and management and display to the client via the client interface.

The processor may be further configured to construct each of the first continuous stream of the digital data and the second continuous stream of the digital data by: setting a predetermined fix number of transactions per batch of the digital data.

The processor may be further configured to: generate a customized aggregate data model that manages transaction counts based on the first and the second continuous streams of the digital data; manage and store the transaction counts via the customized aggregate data model; and integrate the bulk API with the customized aggregate data model.

The bulk API may act as a unified load controller; and the remote application framework may include a cross-platform remote procedure call framework enabling service operations to a remote server application across different operating platforms.

The processor may be further configured to construct the first continuous stream of the digital data by performing a backend call from the flux application to the distributed database management system for the digital data.

The processor may be further configured to: construct at least one virtual machine instance, based on the query, that interacts with the client interface and the bulk API; and construct at least one granular data partition level in the distributed database management system that stores the digital data based on the query, wherein the at least one granular data partition level interacts with the at least one virtual machine.

The processor may be further configured to perform an automatic scaling of the least one virtual machine instances correlating with a quantity of the query received.

According to yet another embodiment, non-transitory computer readable storage medium storing instructions for bulk data processing and management is provided. The non-transitory computer readable storage medium comprising executable code which, when executed by a processor, may cause the processor to: receive a query with a transaction request comprising a bulk data request via a transmission from a client interface; and generate a bulk application program interface (API) comprising a remote application framework integrated with a flux application. The processor may be further configured to construct a first continuous stream of digital data from a distributed database management system via the flux application for transmission to the bulk API; and construct a second continuous stream of the digital data from the bulk API for transmission to the client interface via the remote application framework, wherein the second continuous stream of the digital data is based on the first continuous stream of the digital data. The process may be further configured to derive resulting information regarding the transaction request from parsing the second continuous stream of the digital data by the client interface in correlation with the bulk API; and process the resulting information for storage in a cache for access and management and display to the client via the client interface.

The processor may be further configured to construct each of the first continuous stream of the digital data and the second continuous stream of the digital data by setting a predetermined fix number of transactions per batch of the digital data.

The processor may be further configured to generate a customized aggregate data model that manages transaction counts based on the first and the second continuous streams of the digital data; manage and store the transaction counts via the customized aggregate data model; and integrate the bulk API with the customized aggregate data model.

The bulk API acts as a unified load controller; and the remote application framework comprises a cross-platform remote procedure call framework enabling service operations to a remote server application across different operating platforms.

The processor may be further configured to construct the first continuous stream of the digital data by performing a backend call from the flux application to the distributed database management system for the digital data.

The processor may be further configured to: construct at least one virtual machine instance, based on the query, that interacts with the client interface and the bulk API; construct at least one granular data partition level in the distributed database management system that stores the digital data based on the query, wherein the at least one granular data partition level interacts with the at least one virtual machine; and perform an automatic scaling of the least one virtual machine instances correlating with a quantity of the query received.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for bulk data processing and management.

FIG. 4 illustrates a flowchart of an operational process for bulk data processing and management according to an embodiment.

FIG. 5 illustrates an example process flowchart for the traditional process for handling bulk.

FIG. 6 illustrates an example overview framework for bulk data processing and management according to an embodiment.

FIG. 7 illustrates an example overview framework with a use case application for bulk data processing and management according to an embodiment.

FIG. 8 illustrates an example experimental performance test results for bulk data processing and management according to an embodiment.

FIG. 9 illustrates an example process flow for bulk data processing and management according to an embodiment.

### DETAILED DESCRIPTION

In transaction utilities, thousands up to millions of transactions are frequently being handled and stored across a variety of different systems and operating environments. These transactional data (e.g., financial transaction data) may be provided via performant and resilient application program interfaces (APIs) to different channels, such as the financial institution’s webpage. For instance, if a user has a financial account (e.g., bank account) and the user logs in online to view the recent financial transactions information, this experience is powered by the financial institution’s utility APIs.

Typically, the data being transmitted might not be very large. Common use cases may include fetching transactions for most recent bank account statement, a billing cycle, or viewing specific statements. These scenarios may be efficiently managed by the current APIs. However, new challenges are encountered when the data being accessed is significantly larger.

For example, approximately 200 million transactions involving credit card transactions and deposit transactions are performed daily via the transaction utilities. These transaction data volumes may range from about 2,000 per retail account to 50 million per commercial account.

Consider, for instance, a user with five different financial accounts associated with a financial institution, wherein the financial account may include a checking account, a savings account, and multiple credit card accounts. Thus, creating a high volume of transactions. These transactions may total up to e.g., 50,000 or 60,000 transactions over a long time period of e.g., 24 months. Simple queries like recent transactions may be manageable, but if the user makes a request for all transactions across multiple accounts for the long time period, such queries may not be so manageable anymore the current APIs because of the high-volume of transactions involved. That is, the bulk transactions may overwhelm the current APIs and system architectures.

Indeed, handling this high-volume/bulk amount of data is quite challenging. For instance, a single transaction payload may be about 20 KB. Thus, for a high-volume transaction of e.g., 50K transactions, that amounts to a bulk transaction payload of e.g., 10,00,000 KB (or 1 GB). This volume of data may overwhelm the virtual machine instances running program codes to handle these transaction (e.g., JAVA® virtual machine instances or JVM instances) and cause significant network congestion.

The present application addresses these challenges by enabling a robust solution designed to tackle the challenges of bulk data access in high-volume data systems. Specifically, the present application presents a technological improvement for an enhanced transaction utility (ETU) via a unified load controller, notably a high-volume unified load controller (denoted as HULC) for processing and managing bulk data. The HULC provides a technologically innovative system that leverages a combination of different application programs (e.g., Flux applications and a remote procedural call applications) in conjunction with custom aggregate data models that may achieve efficient performance with an improved infrastructure that may efficiently handle high-volume/bulk transactions in real-time and in generating responses to user queries associated with these high-volume of transactions in a span of only a few seconds. Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

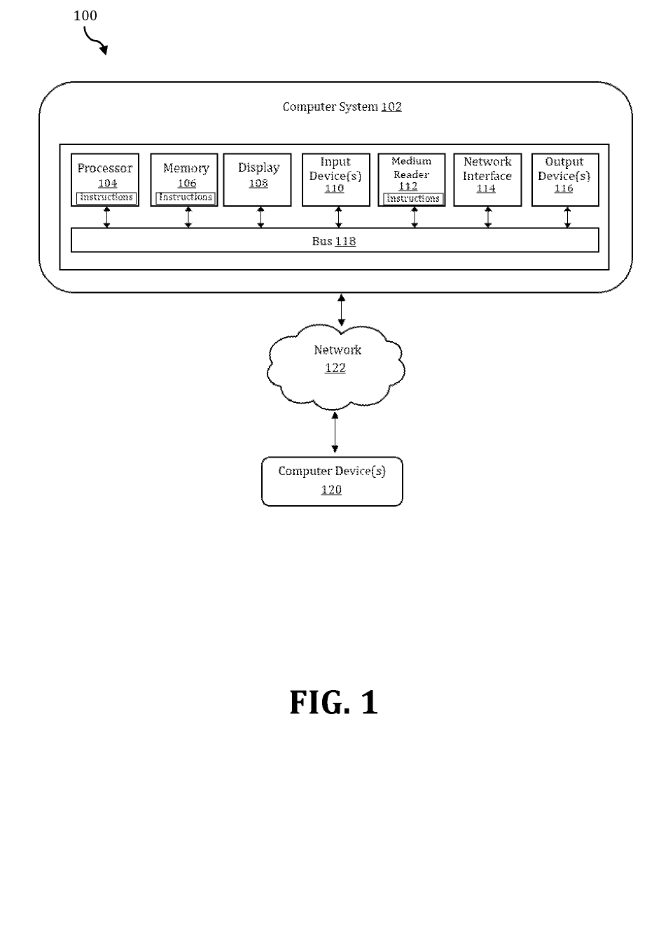

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may include any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide methods and systems for bulk data processing and management by e.g., a bulk application program interface (API) such as a high-volume unified load controller (HULC) as part of an application program interface (API).

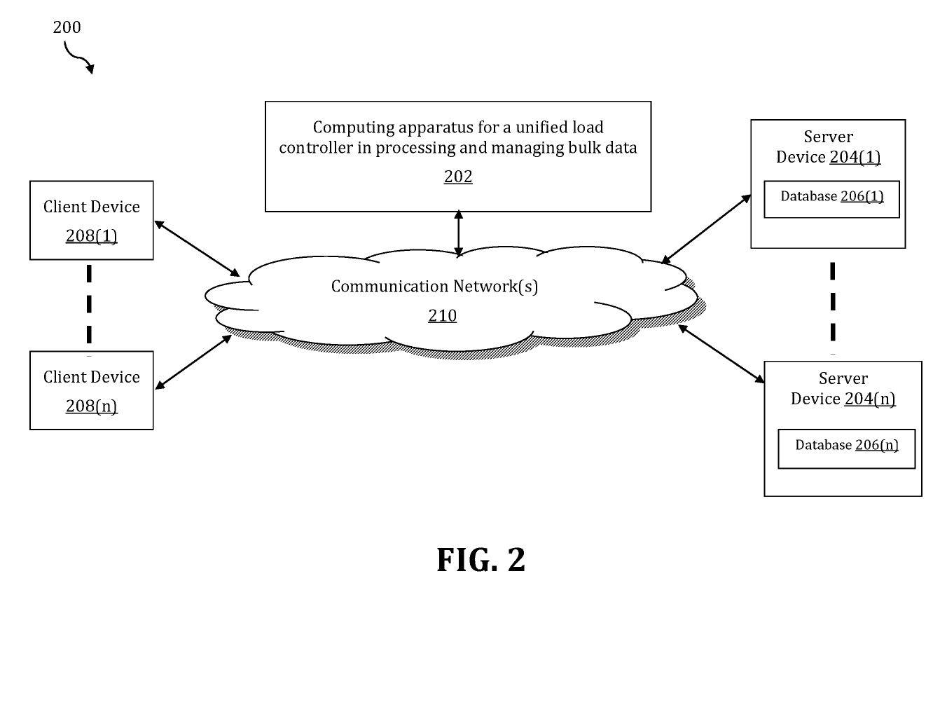

Referring to FIG. 2, a network diagram of a network environment 200 for bulk data processing and management by e.g., a bulk application program interface (API) such as a high-volume unified load controller (HULC), may be illustrated. In an embodiment, the method may be executable on any networked computer platform, such as, for example, a personal computer (PC).

The method for bulk data processing and management by e.g., the HULC, may be implemented by a computing apparatus 202 that implements the bulk data processing and management. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method of bulk data processing and management.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

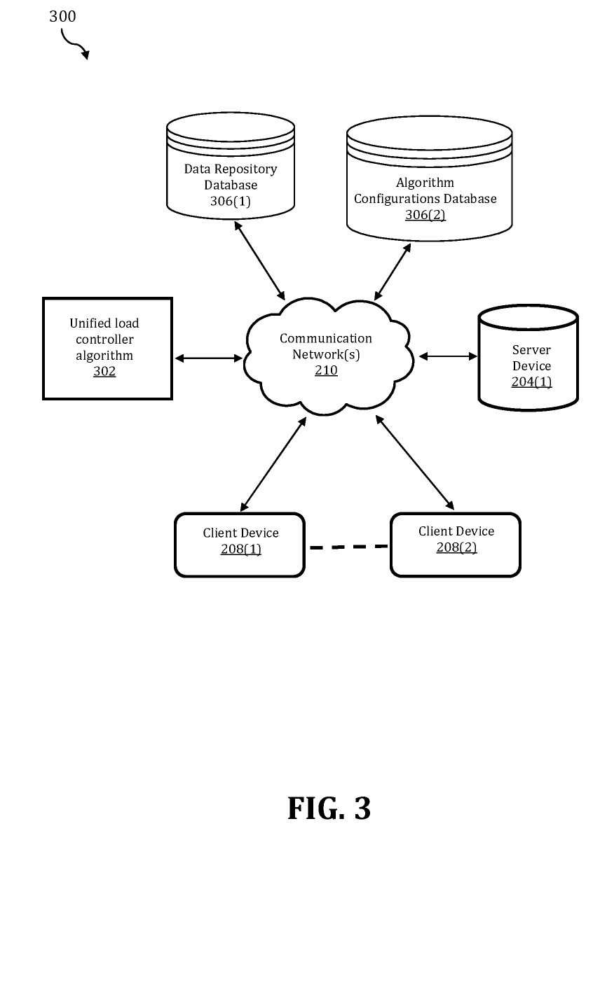

The computing apparatus 202 may be described and illustrated in FIG. 3 as including a unified load controller algorithm 302, notably a high-volume unified load controller (HULC), although it may include other rules, algorithms, policies, modules, databases, or applications, for example. As will be described below, the unified load controller algorithm 302, notably HULC, may be configured to implement a method for bulk data processing and management.

FIG. 3 illustrates a diagram of a system environment 300 for implementing a method for bulk data processing and management of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The unified load controller algorithm 302 may be configured to access these databases for implementing the bulk data processing and management.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

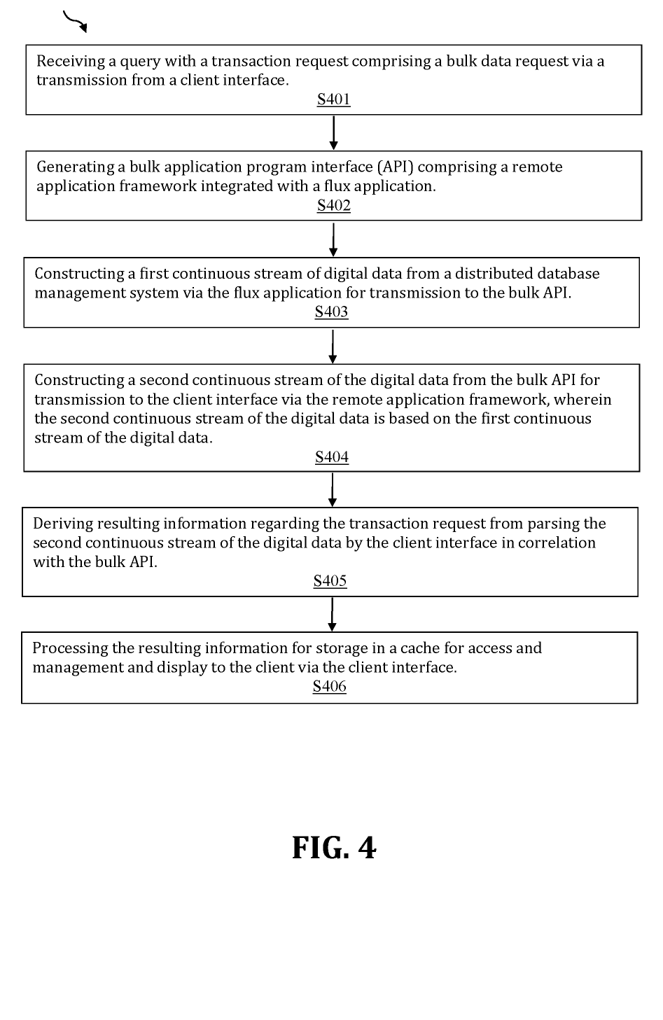

Upon being started, the unified load controller algorithm 302 may execute a process implementing a method for bulk data processing and management. A process for bulk data processing and management may be generally indicated at flowchart 400 in FIG. 4.

FIG. 4 illustrates a flowchart of a process diagram 400 of a process for bulk data processing and management according to an embodiment. The process diagram 400 may be implemented by the system environment 300 of FIG. 3, a network environment 200 of FIG. 2, and the system 100 of FIG. 1.

At step S401 of the flowchart process 400, the computing apparatus 202 may implement the unified load controller algorithm 302 to receive a query with a transaction request that may include a bulk data request via a transmission from a client interface. For instance, the query with a transaction request may be a request for financial transaction data over a certain time period such as, but not limited to, bank account statements over several months or years, credit card statements over several months or years, retail transactions daily or over several months or years, etc. These financial transaction data over a certain time period may represent a bulk data request because it may involve thousands to millions of transactions.

At step S402, the computing apparatus 202 may implement the unified load controller algorithm 302 to generate a bulk application program interface (API) comprising a remote application framework integrated with a flux application. The bulk API may be a unified load controller, notably a high-volume unified load controller (HULC). The high-volume designation may denote bulk data transactions that may range from thousands to millions of transactions. The remote application framework may include a cross-platform remote procedure call (RPC) framework that may enable service operations to a remote server application across different operating platforms. The flux application may be a non-blocking program application (e.g., an online-based program application) for handling data streams. The data streams may be reactive data streams that may involve reactive programming, i.e., a type of declarative program paradigm asynchronously processing of data streams. Non-blocking may refer to a processing technique wherein processing of one data request does not block processing of other data requests.

At step S403, the computing apparatus 202 may implement the unified load controller algorithm 302 to construct a first continuous stream of digital data from a distributed database management system via the flux application for transmission to the bulk API. Constructing the first continuous stream of the digital data may include performing a backend call from the flux application to the distributed database management system for the digital data, wherein the digital data may include the transaction data. Constructing the first continuous stream of the digital data may include setting a predetermined fix number of transactions per batch of the digital data. The predetermined fix number may be based on dividing the digital data needed to process the transaction request into smaller fix amount of the digital data. For example, the predetermined fix number may a transaction amount such as, but not limited to, 5400 transactions with a batch size of 1800, or 15K transactions with a batch size of 2K, or 60K transactions with a batch size of 2500, etc.

At step S404, the computing apparatus 202 may implement the unified load controller algorithm 302 to construct a second continuous stream of the digital data from the bulk API for transmission to the client interface via the remote application framework, wherein the second continuous stream of the digital data is based on the first continuous stream of the digital data. Similarly to the construction of the first continuous stream of the digital data, the construction of the second continuous stream of the digital data may also include setting a predetermined fix number of transactions per batch of the digital data. The predetermined fix number was described above.

At step S405, the computing apparatus 202 may implement the unified load controller algorithm 302 to derive a resulting information regarding the transaction request from parsing the second continuous stream of the digital data by the client interface in correlation with the bulk API. That is, a continual stream of small batches of data may be provided from the bulk API to the client interface such that a search request from the client interface via a query with a transaction request may be provided to the user in an efficient manner.

Additionally, the deriving may also include generating a customized aggregate data model that manages transaction counts based on the first and the second continuous streams of the digital data; managing and storing the transaction counts via the customized aggregate data model; and integrating the bulk API with the customized aggregate data model. The aggregate data model may tabulate data that may include account data identifier (e.g., an account number), month, and transactions count, as well as the type of data object (e.g., a transaction data object).

At step S406, the computing apparatus 202 may implement the unified load controller algorithm 302 to process the resulting information for storage in a cache for access and management and display to the client via the client interface. The cache may enable the user to ingest the data stream in an efficient and timely manner.

Continuing with FIG. 4, it may be noted that the process steps may further include constructing at least one virtual machine instance, based on the query, that interacts with the client interface and the bulk API; and constructing at least one granular data partition level in the distributed database management system that stores the digital data based on the query. The at least one granular data partition level may interact with the at least one virtual machine, wherein the virtual machine may be virtual machines instances running program codes to handle these transaction (e.g., Java® virtual machine instances or JVM instances). The at least one virtual machine, i.e., virtual machine instances, may be automatically scale to correlate with a quantity of the query received. For example, if a million queries need to run in parallel and each VM may handle 1000 threads, then the virtual machine instances may autoscale to 1000 instances using the flux application.

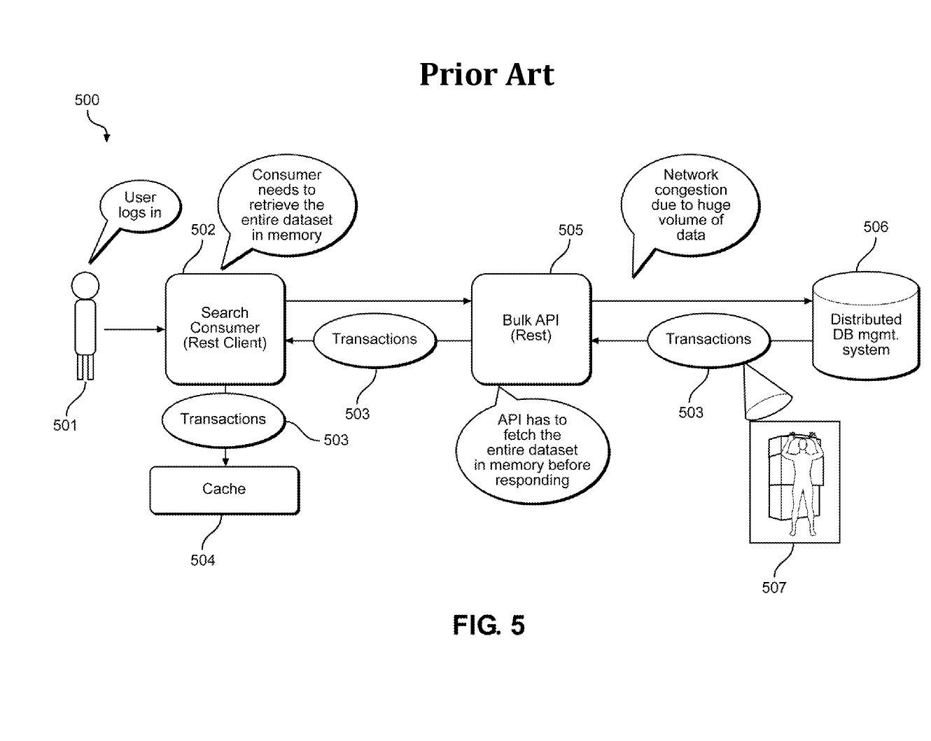

FIG. 5 illustrates an example process flowchart 500 showing the traditional process for handling bulk data that the present application (as described in an embodiment in FIG. 4) improves upon. Example process flowchart 500 shows a search use based on a traditional representational state transfer (REST) application program interface (API). REST is a program architecture style that defines constraints on how data systems may behave. For instance, REST may define a uniformity of interfaces, interaction scalability between different independent program components, etc. REST was the program architecture utilized to develop the World Wide Web.

In example process flowchart 500 with a search use case, a user 501 may log into a system, e.g., a financial system, to perform a search of the user’s financial records (e.g., a query with a transaction request) using a REST client 502. The user needs to retrieve the entire data set from memory in order to access their financial transaction data to perform the search. Thus, the search may be performed started at the REST client 502 with the query being sent to the bulk API, which may be the REST API 505. The REST client 502 is an interface for interacting with the user and enabling the user to access the actual REST API 505.

The REST API 505 may then access the data, which may include the financial transaction data, from a memory storage system such as a distributed database management system 506. That is, the REST API 505 has to fetch the entire data set from the memory storage system before being able to respond to the user’s query. Indeed, transactions 503 (may include financial transactions) must be fetched by the REST API 505 from the memory storage system. However, given a limited bandwidth, network congestion may occur when the REST API 505 seeks to fetch these data from the memory storage system if the request involves too large an amount (i.e., high-volume or bulk amount) of data that must be fetched. From these data and transactions 503, the financial transactions the user seeks would have to be searched 507.

Continuing with the example process flowchart 500, the REST API 505 may then provide these transactions 503 that was fetched from the memory storage system to the REST client 502 for the user to access. These transactions 503 may also be transmitted from the REST client 502 to the cache 504 for caching.

As may be seen in FIG. 5, the example process flowchart 500 has several limitations. For instance, there may be a performance overhead, wherein multiple web-based (i.e., HTTP) requests at the REST client 502 may increase latency. Another limitation may be

limited data transfer options, wherein data object notations (e.g., JSON) and extensible mark-up language (XML) may be inefficient for large data due to a parsing overhead and verbosity. Another limitation may be transaction management due to manual handling for bulk data operations, which is tedious, costly, and time consuming when bulk data is involved. Another limitation may be scalability challenges because it is difficult to scale REST APIs.

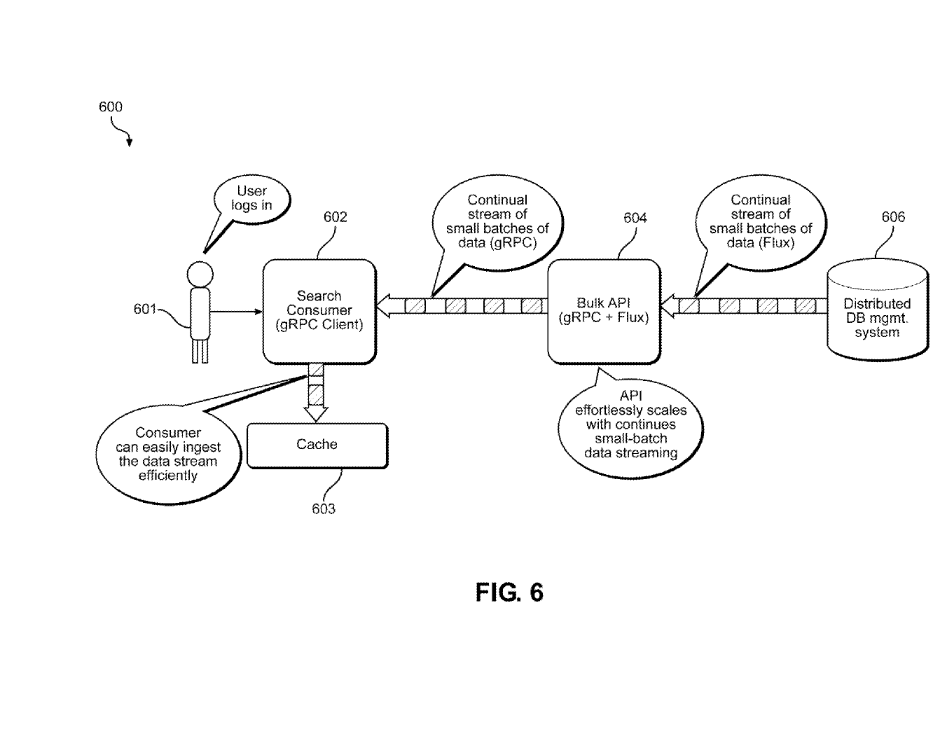

Indeed, the traditional process as shown in the example process flowchart 500 is a cumbersome process given the bulk data involved and the user’s expectation of a nearly instantaneous response to the user’s query. Indeed, the single application instance in the example process flowchart 500 is unable to manage such a high-volume of data due to having limited resources, especially since the high-volume of data may involve transactions per account that may range, on average, from thousands (e.g., 2K) of transactions for retail accounts to millions (e.g., 50 million) of transactions for commercial accounts. Additionally, while a memory storage system such as a distributed database management system 506 may be a low latency data store, this is insufficient to help manage such a high-volume of data. Accordingly, the present application (as described in FIG. 6 and the subsequent figures) provide an improvement on the traditional process of FIG. 5

FIG. 6 illustrates an example overview framework 600 for bulk data processing and management according to an embodiment as described in FIG. 4.

Example overview framework 600 may provide an innovative system by leveraging a combination of a flux application, a RPC, and custom aggregate data models to achieve efficient performance and efficient infrastructure for bulk data processing and management.

Example overview framework 600 may show a search use case based on a bulk API 604 with a remote application framework that may include a cross-platform remote procedure call (RPC) framework and a flux application. It is noted that although the RPC may be shown in FIG. 6 as gRPC (i.e., GOOGLE® RPC), any RPC may be used. The RPC may enable service operations to a remote server application across different operating platforms. The flux application may be a non-blocking program application (e.g., an online-based program application) for handling data streams. The data streams may be reactive data streams that may involve reactive programming, i.e., a type of declarative program paradigm asynchronously processing of data streams. The data in the data streams may be transaction data, e.g., financial transaction data. Non-blocking may refer to a processing technique wherein processing of one data request does not block processing of other data requests.

Continuing with the example overview framework 600, the integration with a flux application may enable flexible and reactive backend calls to the memory storage system such as a distributed database management system 606. Thus, ensuring responsive and efficient data handling. Additionally, the implementation of RPC for communication may enable for high-performance and low-latency data transmission. Thus, enabling rapid communications between different services, applications, and for users in accessing and utilizing the different services and applications. Additionally, the utilization of custom aggregate data models may generate custom aggregate tables to efficiently store and manage transaction counts, thus optimizing query performance and data retrieval.

In the example overview framework 600, a user 601 may log into a system, e.g., a financial system, to perform a search of the user’s financial records (e.g., a query related to a transaction request) using an RPC client 602. The RPC client 602 may be an interface for interacting with the user and enabling the user to access the actual bulk API 604.

The bulk API 604 may operate as an enhanced transaction utility (ETU) via a unified load controller, notably a high-volume unified load controller (denoted as HULC) for processing and managing bulk data. The bulk API 604 may include the RPC and the flux application. A continual stream of small batches of data, i.e., a first continuous stream of digital data, may be constructed and transmitted from a memory storage system such as a distributed database management system 606 to bulk API 604 via the flux application. The construction of the first continuous stream may include setting a predetermined fix number of transactions per batch of the digital data. The predetermined fix number of transactions was previously described. Based on the first continuous stream, another continuous stream of the digital data, i.e., a second continuous stream of the digital data, may be transmitted from the bulk API 604 to the RPC client 602 via the remote application framework. That is, another continual stream of small batches of data, i.e., the second continuous stream of the digital data, may be transmitted from the bulk API 604 to the RPC client 602 for the user to access. The RPC client 602 may then provide the continual stream of small batches of data may also be transmitted from the RPC client 602 to the cache 603 for caching.

In contrast to the traditional process as shown in the example process flowchart 500, the continuous stream of small batches of data in the example overview framework 600 of the present application negates the need to fetch an entire data set from the memory storage system each time a user makes a query with a transaction request. Thus, preventing network congestion and enabling a near instantaneous response to the user’s query. The near instantaneous may be several milliseconds or seconds. This advantage may be derived from the architecture framework incorporating the flux application, the RPC, and the custom aggregate data models. Notably, the bulk API 604 may effortlessly scale in correlation to (i.e., with) the continuous stream of small batches of data.

As such, the example overview framework 600 with the bulk API 604 that may be HULC provides advantages over the status quo by providing technological improvements through improved performance, efficient utilization of infrastructure, scalability, and generation of high-volume/bulk resulting data sets. The improved performance may be derived from combining the flux application, the RPC, and custom aggregate data models to delivers an improved performance over the status quo capable of handling high-volume/bulk data sets with ease. The efficient utilization of infrastructure may be derived from an optimization of resource usage, ensuring that the infrastructure may be efficiently utilized in handling high-volume/bulk data volumes without unnecessary overhead.

Continuing with the technological improvements, the scalability may be derived from the example overview framework 600 being designed to scale seamlessly, thus enabling the managing of increasing data loads and user demands, which is ideal for growing systems. The generation of high-volume/bulk resulting data sets may stem from the example overview framework 600 being capable of delivering high-volume/bulk result data sets that would otherwise be difficult to manage. Thus, the example overview framework 600 ensures that even the most demanding data requirements may be met, e.g. data demands for transaction requests involving thousands to millions of transaction data.

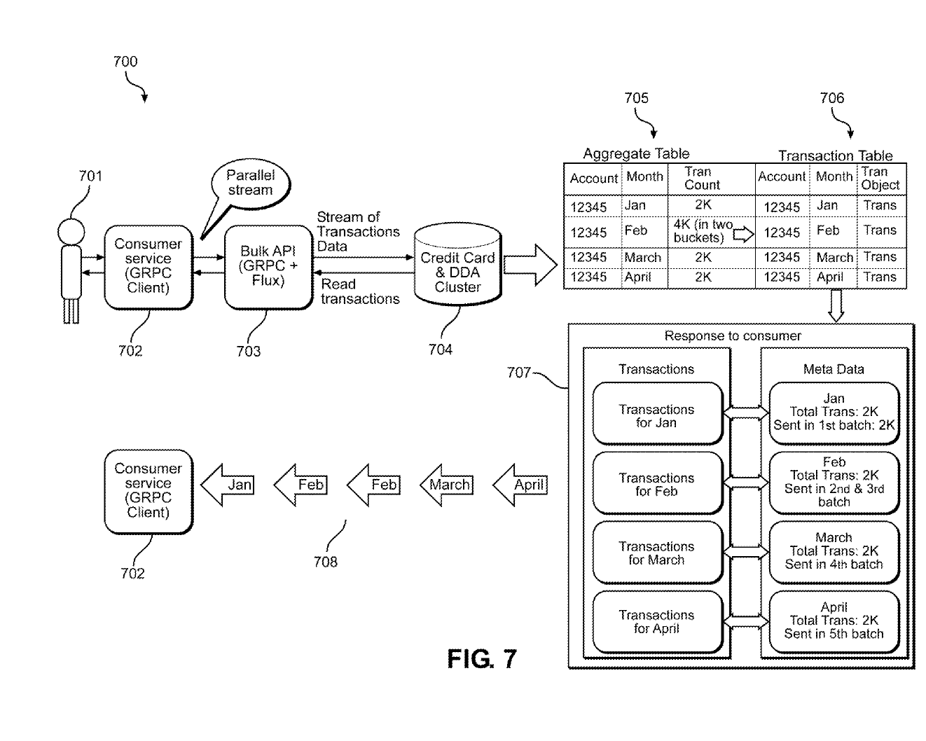

FIG. 7 illustrates an example overview framework 700 with a use case application for bulk data processing and management according to an embodiment as described in FIG. 4. The example overview framework 700 may show an enhanced transaction utility (ETU) via a unified load controller, notably a high-volume unified load controller (denoted as HULC) for processing and managing bulk data. The bulk API 703 may operate as an ETU, i.e., as a HULC for processing and managing bulk data. The example overview framework 700 may be similar to the example overview framework 600 since both are showing similar processes involving the same bulk API and RPC client, albeit with varying additional details. The example overview framework 700 may provide additional details regarding an aggregate data model table 705 and a transaction table 706.

Example overview framework 700 may show a search use case based on a bulk API 703 with a remote application framework that may include a cross-platform remote procedure call (RPC) framework and a flux application. It is noted that although the RPC may be shown in FIG. 7 as gRPC (i.e., GOOGLE® RPC), any RPC may be used. The RPC may enable service operations to a remote server application across different operating platforms. The flux application may be a non-blocking program application (e.g., an online-based program application) for handling data streams. The data streams may be reactive data streams that may involve reactive programming, i.e., a type of declarative program paradigm asynchronously processing of data streams. The data in the data streams may be transaction data such as financial transactions. Non-blocking may refer to a processing technique wherein processing of one data request does not block processing of other data requests.

In the example overview framework 700, a user 701 may log into a system, e.g., a financial system, to perform a search of the user’s financial records (e.g., a query related to a transaction request) using an RPC client 702. The RPC client 702 may be an interface for interacting with the user and enabling the user to access the actual bulk API 703. The data streams between the bulk API 703 and RPC client 702 may operate in parallel, with data being transmitted to and from the bulk API 703 and RPC client 702. As previously stated, the data in the data streams may be transaction data such as financial transactions.

Continuing with the example overview framework 700, stream of transactions data may be transmitted from the bulk API 703 to memory storage system such as a distributed database management system 704. The memory storage system such as the distributed database management system 704 may store credit card transaction data and daily deposit account (DDA) transaction data. The read transactions may be transmitted from the memory storage system such as the distributed database management system 704 to the bulk API 702 for the user 701 to access.

The process involved in implementing the example overview framework 700 for processing the data streams such that a result may be generated with the relevant financial data to answer the user’s search query may include the creation of an aggregate data model table 705 and a transaction table 706 as part of the example overview framework 700. The aggregate data model table 705 may be created to store transaction counts. For instance, an account number 12345 may have 2K transaction counts in the month of January for a certain year (year not shown).

The transaction table 706 may provide information on data type, such as transaction data, for that account number in that particular time frame. So, using the same example as described for the aggregate data model table 705, the account number 12345 with 2K transaction counts in the month of January for a certain year may have a transaction data object of “trans” to denote transaction. Essentially, the transaction table 706 may provide information regarding a data type, i.e., that the data being stored and accessed are related to transactions, which is what the user is searching for. Other data types that are not transaction data would not be needed since they are not what the user is searching for.

Going back to the aggregate data model table 705, it may be seen for the month of February that the transaction counts may be 4K in two buckets. That may denote that the transaction count may occur in two data buckets for a total of 4K, i.e., two data batches. The arrow need not be specific to just the February entry, but may denote that transaction count data from the aggregate data model table 705 may then be categorized by the transaction table 706 as being of transaction data type.

Based on the data obtained in the aggregate data model table 705 and a transaction table 706, a response to the user/consumer 707 may be generated. The response to the user/consumer 707 may include transaction data for each month of a certain year as may be derived from the metadata associated with the month of a certain year (year not shown). So, for example, the transactions for January, which may have a total of 2K transactions, may be sent in a first batch of the data stream as part of the response to the user/consumer 707. Continuing the example, the transactions for February, which may have a total of 2K transactions, may be sent in a second batch and a third batch of the data stream as part of the response to the user/consumer 707. And so forth as may be shown in the response to the user/consumer 707. These data batches for the relevant months as part of response to the user/consumer 707 may then be transmitted 708 to the RPC client 702. The relevant months may be determined based on the user’s query, e.g., the user may request financial transactions data for the months of January to April of a certain year.

The advantages and technological improvements of the example overview framework 700, similarly to the example overview framework 600, may be, e.g., providing customized batch sizes via the bulk API with the integration of the RPC framework (such as the RPC client) and the flux application. The integration of the RPC framework may enable data to be transmitted efficiently to users via continuous streams of small batches of data, enabling efficient data transmission and communication with users. The integration of the flux application may enable backend calls to a database (e.g., a memory storage system such as a distributed database management system) with flexibility in query handling and retrieve data in a continuous stream of small batches. Thus, customized batch sizes may be generated, enabling an optimized processing since a fixed number of transactions per batch may be set.

As such, the example overview framework 700, similarly to the example overview framework 600, may provide enhanced performance through optimized batch processing, improved scalability and flexibility in handling large data volumes, and streamlined API operations with customized transaction management. The example overview framework 700, similarly to the example overview framework 600, may be expanded and utilized for other services besides financial transaction queries. Indeed, the capabilities of the framework as described in the present application may be implemented in any service wherein a user needs to make a query for their data records, e.g., medical records, education records, etc. The implementation of this framework to these other services may enable continuous optimization of batch size and transaction handling in these other services as well.

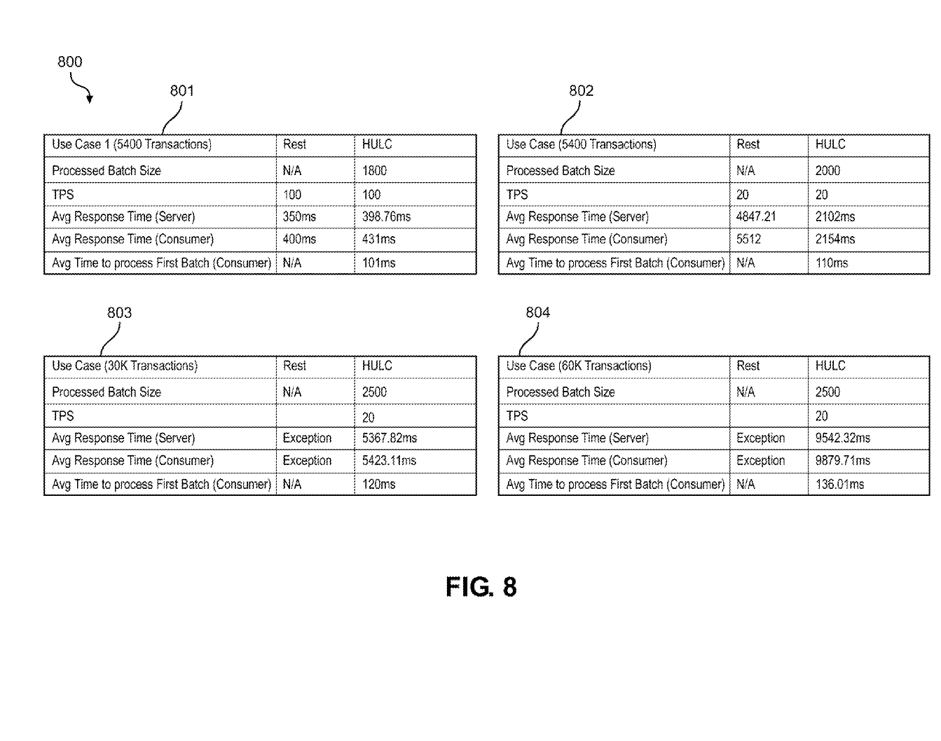

FIG. 8 illustrates an example experimental performance test results 800 for bulk data processing and management according to an embodiment as described in FIG. 4. Notably, the example experimental performance test results 800 shows a comparison between the REST, i.e., REST API (as described in FIG. 5) and the framework of the present application with the HULC (as described in FIGS. 6 and 7). The performance tests may compare the capabilities of REST and HULC for handling transactional loads.

Continuing with FIG. 8, REST was able to handle up to 5400 transactions with an average response time of 400 ms. However, REST struggled with larger loads, failing to sustain performance beyond 20K transactions. In contrast, HULC demonstrated significantly higher performance, handling up to 60K transactions successfully. Indeed, as shown in use case 803, processing 30K transactions took HULC approximately over 5 seconds (i.e., 5423.11 ms) via the continuous stream of small batches of data, while processing the entire dataset of 60K transactions as shown in use case 804 took approximately over 9 seconds (i.e., 9879.71 ms) via the continuous stream of small batches of data. In contrast, REST failed with these high-volume/bulk transactions (“exception”) as shown in use cases 803 and 804. The “exception” essentially denoting an error by REST. REST fails because a memory storage system or database may typically hang processing of high-volume/bulk data or take hours to run for such queries. The virtual machine instances that handle the processing of these queries may crash when they are loaded with one load of this high-volume/bulk data from the database. Then, the client query will time out while waiting for the huge result set that would be transmitted from the virtual machine instances through the network to the user/client API.

The example uses cases 801-804 show different transaction sizes ranging from 5400 transactions to 60K transactions and compares the performance of REST and HULC by tracking average server response times, average consumer response times, transaction processing system (TPS), and average time to process a first batch of data for the user/consumer. In use case 801, it may be seen that for 5400 transactions, REST has an average response time to the user/consumer of 400 ms, while HULC has an average response time to the user/consumer of 431 ms. When the transactions amount increases to 15K transactions (use case 802), REST has an average response time to the user/consumer of 5512 ms, while HULC may have an average response time to the user/consumer of 2154 ms. At a transactions amount of 30K (use case 803), REST is no longer able to perform, whereas HULC may provide an average response time to the user/consumer of 5423.11 ms. Then, at an even higher transactions amount of 60K (use case 804), REST remains unable to perform, whereas HULC may provide an average response time to the user/consumer of 9879.71 ms.

As such, the example experimental performance test results 800 as shown in use cases 801-804 demonstrates the superiority of HULC over REST for handling higher volume/ bulk data processing tasks and improving overall system efficiency and scalability. Indeed, as the transactions amount increase, HULC is capable of handling high-volume/bulk data in an expedient and efficient manner to generate a fast response to the user as demonstrated by HULC’s fast response time to the user (e.g., approximately over 5 seconds for 30K transactions in use case 803 and approximately over 9 seconds for 60K transactions in use case 804). In contrast, REST failed (“exception”) and is unable to handle high-volume/bulk transaction tasks

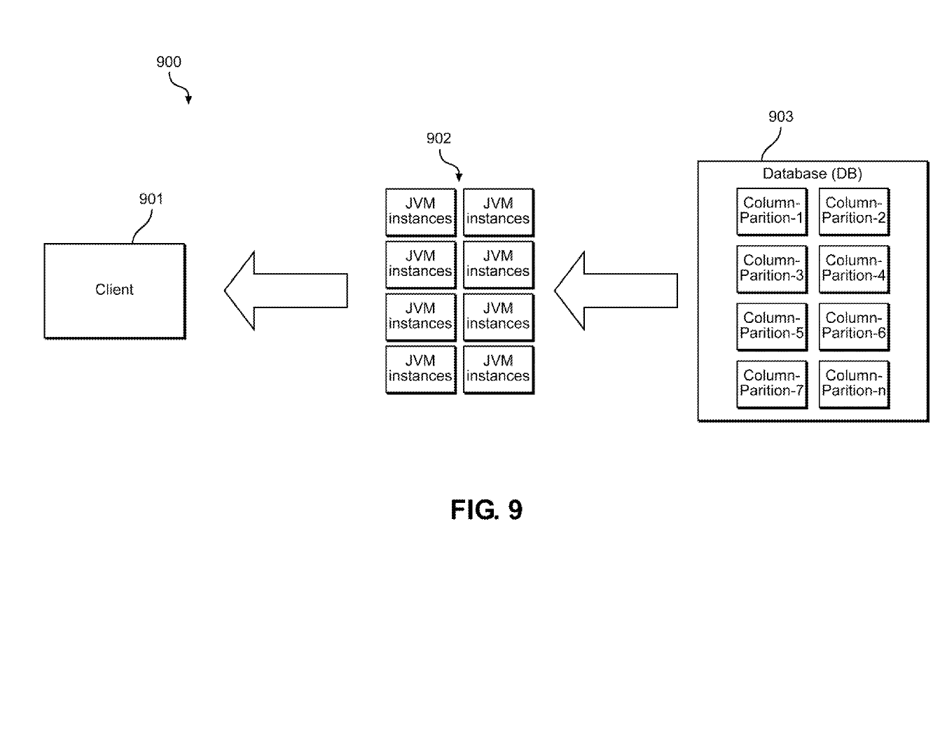

Consider, for instance, an example wherein a corporate retail user/client may input a query requesting all transactions for a month. Such a request may run well over, e.g., a 100 million transactions. That is, transaction involving a high-volume/bulk data. With the status quo using traditional techniques such as REST, this request can fail. Additionally, using other traditional techniques such as file transfer protocol (FTP) would generate a huge file and typically takes 15 mins. In contrast to these traditional techniques, the corporate retail user/client may get a near instantaneous result, e.g., within several milliseconds or seconds. HULC may achieve a near instantaneous result through a combination of efficient data storage and management, aggregated data model tables, flux application, continuous stream of data with the RPC framework, auto-scaling of virtual machine instances at run time. This combination may enable a powerful mechanism in which high-volume/bulk data may be processed, loaded, and read on a real-time basis. The virtual machine autoscaling is described further in FIG. 9.

FIG. 9 illustrates an example process flow 900 for bulk data processing and management according to an embodiment as described in FIG. 4. The example process flow 900 may show how HULC handles high-volume/bulk data transactions. Notably, based on a number of queries with a transaction request that users/clients 901 make, the virtual machine instances 902 may autoscale based on the number of queries. That is, the virtual machine instances 902 may autoscale depending on the number of partitions that may be needed for the queries. So, for example, if a million queries need to be run in parallel and each virtual machine instances of the virtual machine instances 902 may handle 1000 threads, then the virtual machine instances 902 may autoscale to 1000 instances using the flux application. Although the example process flow 900 may show JVM instances (i.e., JAVA® virtual machines instances), any applicable virtual machine instances may be utilized.

Continuing with the example process flow 900, database (DB) may show column partition 903 may enable column data storage at a highly granular partition level, enabling HULC to handle millions of queries and respond with response times of sub-seconds (see FIG. 8 for the various response time results). That is, data is stored in aggregated data model tables via column partition for column data storage may be an efficient manner in storing data. Additionally, the columnar database may enable superfast retrieval at a sub-second time (e.g., milliseconds or seconds) level. These column data storage may scale to obtain data reads up to e.g., 10 million data/sec. The data in the column partition 903 may be provided to the virtual machine instances 902, wherein the virtual machine instances 902 may then provide this data to the users/clients 901.

Additionally, the flux application may be multi-thread and may scale up to e.g., tens of thousands of threads spread across multiple virtual machine instances 902 that may query the memory storage system for the data stored in the column partition and retrieve this data. The RPC framework may then stream this data in real-time to user/consumer.

As such, HULC provides the users/clients 901 may achieve immediate real-time responses to their queries via a continuous data stream through the bulk API with the RPC client and flux application.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

Although the present specification describes various numeric values, it is noted that these values are example values and are not intended to limit or restrict the present application to those values. Accordingly, replacement values having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for bulk data processing and management, the method being implemented by at least one processor, the method comprising:
receiving a query with a transaction request comprising a bulk data request via a transmission from a client interface;
generating a bulk application program interface (API) comprising a remote application framework integrated with a flux application;
constructing a first continuous stream of digital data from a distributed database management system via the flux application for transmission to the bulk API;
constructing a second continuous stream of the digital data from the bulk API for transmission to the client interface via the remote application framework, wherein the second continuous stream of the digital data is based on the first continuous stream of the digital data;
deriving resulting information regarding the transaction request from parsing the second continuous stream of the digital data by the client interface in correlation with the bulk API; and
processing the resulting information for storage in a cache for access and management and display to the client via the client interface.

2. The method of claim 1, wherein each of the constructing the first continuous stream of the digital data and the constructing the second continuous stream of the digital data further comprises:
setting a predetermined fix number of transactions per batch of the digital data.

3. The method of claim 1, further comprising:
generating a customized aggregate data model that manages transaction counts based on the first and the second continuous streams of the digital data;
managing and storing the transaction counts via the customized aggregate data model; and
integrating the bulk API with the customized aggregate data model.

4. The method of claim 1, wherein the bulk API acts as a unified load controller; and
wherein the remote application framework comprises a cross-platform remote procedure call framework enabling service operations to a remote server application across different operating platforms.

5. The method of claim 1, wherein the constructing the first continuous stream of the digital data comprises performing a backend call from the flux application to the distributed database management system for the digital data.

6. The method of claim 1, further comprising:
constructing at least one virtual machine instance, based on the query, that interacts with the client interface and the bulk API; and
constructing at least one granular data partition level in the distributed database management system that stores the digital data based on the query, wherein the at least one granular data partition level interacts with the at least one virtual machine.

7. The method of claim 6, further comprising:
performing an automatic scaling of the least one virtual machine instances correlating with a quantity of the query received.

8. A computing apparatus for bulk data processing and management, comprising:
a processor;
a memory;
a display; and
a communication interface coupled to each of the processor, the memory, and the display, wherein the processor is configured to:
receive a query with a transaction request comprising a bulk data request via a transmission from a client interface;
generate a bulk application program interface (API) comprising a remote application framework integrated with a flux application;
construct a first continuous stream of digital data from a distributed database management system via the flux application for transmission to the bulk API;
construct a second continuous stream of the digital data from the bulk API for transmission to the client interface via the remote application framework, wherein the second continuous stream of the digital data is based on the first continuous stream of the digital data;
derive resulting information regarding the transaction request from parsing the second continuous stream of the digital data by the client interface in correlation with the bulk API; and
process the resulting information for storage in a cache for access and management and display to the client via the client interface.

9. The computing apparatus of claim 8, wherein the processor is further configured to
construct each of the first continuous stream of the digital data and the second continuous stream of the digital data by:
setting a predetermined fix number of transactions per batch of the digital data.

10. The computing apparatus of claim 8, wherein the processor is further configured to:
generate a customized aggregate data model that manages transaction counts based on the first and the second continuous streams of the digital data;
manage and store the transaction counts via the customized aggregate data model; and
integrate the bulk API with the customized aggregate data model.

11. The computing apparatus of claim 8, wherein the bulk API acts as a unified load controller; and
wherein the remote application framework comprises a cross-platform remote procedure call framework enabling service operations to a remote server application across different operating platforms.

12. The computing apparatus of claim 8, wherein the processor is further configured to construct the first continuous stream of the digital data by performing a backend call from the flux application to the distributed database management system for the digital data.

13. The computing apparatus of claim 8, wherein the processor is further configured to:
construct at least one virtual machine instance, based on the query, that interacts with the client interface and the bulk API; and
construct at least one granular data partition level in the distributed database management system that stores the digital data based on the query, wherein the at least one granular data partition level interacts with the at least one virtual machine.

14. The computing apparatus of claim 13, wherein the processor is further configured to perform an automatic scaling of the least one virtual machine instances correlating with a quantity of the query received.

15. A non-transitory computer readable storage medium storing instructions for bulk data processing and management, the non-transitory computer readable storage medium comprising executable code which, when executed by a processor, causes the processor to:
receive a query with a transaction request comprising a bulk data request via a transmission from a client interface;
generate a bulk application program interface (API) comprising a remote application framework integrated with a flux application;
construct a first continuous stream of digital data from a distributed database management system via the flux application for transmission to the bulk API;
construct a second continuous stream of the digital data from the bulk API for transmission to the client interface via the remote application framework, wherein the second continuous stream of the digital data is based on the first continuous stream of the digital data;
derive resulting information regarding the transaction request from parsing the second continuous stream of the digital data by the client interface in correlation with the bulk API; and
process the resulting information for storage in a cache for access and management and display to the client via the client interface.

16. The non-transitory computer readable storage medium of claim 15, wherein the non-transitory computer readable storage medium further causes the processor to construct each of the first continuous stream of the digital data and the second continuous stream of the digital data by:
setting a predetermined fix number of transactions per batch of the digital data.

17. The non-transitory computer readable storage medium of claim 15, wherein the non-transitory computer readable storage medium further causes the processor to:
generate a customized aggregate data model that manages transaction counts based on the first and the second continuous streams of the digital data;
manage and store the transaction counts via the customized aggregate data model; and
integrate the bulk API with the customized aggregate data model.

18. The non-transitory computer readable storage medium of claim 15, wherein the bulk API acts as a unified load controller; and
wherein the remote application framework comprises a cross-platform remote procedure call framework enabling service operations to a remote server application across different operating platforms.

19. The non-transitory computer readable storage medium of claim 15, wherein the non-transitory computer readable storage medium further causes the processor to construct the first continuous stream of the digital data by performing a backend call from the flux application to the distributed database management system for the digital data.

20. The non-transitory computer readable storage medium of claim 15, wherein the non-transitory computer readable storage medium further causes the processor to:
construct at least one virtual machine instance, based on the query, that interacts with the client interface and the bulk API;
construct at least one granular data partition level in the distributed database management system that stores the digital data based on the query, wherein the at least one granular data partition level interacts with the at least one virtual machine; and
perform an automatic scaling of the least one virtual machine instances correlating with a quantity of the query received.
